(19) United States
(12) Patent Application Publication
(10) Pub. No.: US 2003/0117294 A1
(43) Pub. Date: Jun. 26, 2003

(54) Remote control transmitter and transmit/receive system using the same

(76) Inventors: Yoichi Hatano, Osaka (JP); Noriaki Matsui, Fukui (JP)

Correspondence Address: RATNERPRESTIA, P O BOX 980, VALLEY FORGE, PA, 19482-0980, US

(21) Appl. No.: 10/309,663

(22) Filed: Dec. 4, 2002

(30) Foreign Application Priority Data
Dec. 5, 2001 (JP) 2001-371271

(51) Int. Cl. G08C 19/00

(52) U.S. Cl. 340/825.72; 348/734; 345/169

(57) ABSTRACT

A remote control transmitter has an operating unit having a plurality of operating keys, a storage unit for storing data including bit data, an expansion program, and a common program, a control unit for generating a transmission format based on the expansion program, the common program, and the bit data, and a transmitting unit for transmitting the transmission format as a remote control signal. A transmit/receive system includes the remote control transmitter and an instrument having a remote control receiver for receiving the transmission format, and the remote control transmitter remotely controls the instrument.

### FIELD OF THE INVENTION

The present invention relates to a preset-type remote control transmitter capable of remotely controlling a plurality of electronic instruments, and a transmit/receive system using it.

### BACKGROUND OF THE INVENTION

Recently, various electronic instruments such as a television and a video tape recorder have become widespread, and a remote control transmitter that can remotely control the various electronic instruments by itself, a so-called preset-type remote control transmitter, has been widely used. The conventional remote control transmitter will be described with reference to FIG. 4 to FIG. 9.

FIG. 4 is a block diagram of the conventional remote control transmitter. In FIG. 4, operating unit 401 has a plurality of operating keys, storage unit 403 comprises a microcomputer and various electronic components, and control unit 402 comprises a microcomputer and various electronic components. Storage unit 403 stores various data used for remotely controlling an instrument. Transmitting unit 404 has an infrared light emitting diode and the like. Operating unit 401, storage unit 403, and transmitting unit 404 are connected to control unit 402. Control unit 402 reads data out of storage unit 403 in response to an operation of operating unit 401, and generates a transmission format. Transmitting unit 404 transmits the transmission format as a remote control signal. The remote control transmitter has such a configuration.

The transmission format that is transmitted as the remote control signal from the remote control transmitter having the configuration is described with reference to FIG. 5A to FIG. 5C and FIG. 6.

The transmission format is usually formed of a custom code for determining a manufacturer of the transmitter and a kind of the instrument, a data code assigned to each operating key, and the like. Each of these codes has a different number of bits and different bit width.

FIG. 5A to FIG. 5C illustrate three different kinds of transmission formats. FIG. 5A shows transmission format A. Transmission format A comprises 1 bit of header 501, 5 bits of custom code 502, 6 bits of data code 503, 5 bits of inverse custom code 504, 6 bits of inverse data code 505, and 1 bit of end code 506, in that order. When the operating keys are pressed and held, all codes are repeated in a cycle of about 105 ms.

FIG. 5B shows transmission format B. Transmission format B comprises a header, an 8-bits of custom code, an 8-bits of data code, an 8-bits of inverse custom code, and an 8-bits of inverse data code. When the operating keys are pressed and held, not these codes but only a repeat code is output after the above header and codes.

FIG. 5C shows transmission format C. Transmission format C has no header, and comprises a 3-bits of custom code, a 7-bits of data code, and an end code. When the operating keys are pressed and held, all codes are repeated in a cycle of about 25 ms.

The number of bits and time width of each of the header and the codes formed by combinations of “0” and “1” in each transmission format are determined for each transmission format as shown in bit data in FIG. 6.

A program for generating each transmission format is usually, individually determined depending on the manufacturer or the kind of the instrument. Individual programs A, B, C including the number of bits and time width of each code and the combination of “0” and “1” of each code are stored in storage unit 403 in FIG. 4.

When a predetermined operating key of operating unit 401 is operated, control unit 402 reads the programs out of storage unit 403 and generates each transmission format, and transmitting unit 404 transmits the transmission format as a remote control signal.

Specific and individual programs A, B, C used for generating respective different transmission formats A, B, C are shown in FIG. 7 to FIG. 9.

A case of generating and transmitting transmission format A is described with reference to a flowchart in FIG. 7.

Firstly, when “1” key is operated twice while a predetermined operating key of operating unit 401, for example the “power” key, is operated, a television of manufacturer A, for example, is selected. Next, when the “volume +” key, for example, is operated, control unit 402 reads individual program A of transmission format A shown in FIG. 7 out of storage unit 403 based on the key operation.

Control unit 402 uses data in individual program A to read out a time width (it is called HIGH width hereinafter) of high level in the header and a time width (it is called LOW width hereinafter) of low level, and supplies them to transmitting unit 404. Transmitting unit 404 transmits them as a remote control signal such as an infrared ray to an instrument to be remotely operated, for example, a television.

Based on respective HIGH widths and LOW widths of “0” and “1”, 5 bits of custom code of “10110”, 6 bits of data code of “000001”, 5 bits of inverse custom code of “01001”, 6 bits of inverse data code of “111110” are generated.

The number of bits in the counter of the custom code is set at 5, the counter of the data code is set at 6, the counter of the inverse custom code is set at 5, and the counter of the inverse data code is set at 6, and then each of the codes is transmitted from transmitting unit 404 sequentially by 1 bit. At this time, the counter of each code is decremented by 1 every 1-bit transmission. The 5 bits of custom code is taken as an example. After 5 bits are transmitted, the counter indicates 0 and the next data code is transmitted. Thus, each code is transmitted while the number of bits in the code is counted.

The end code is transmitted after the sixth bit of the inverse data code, and then the input of the operating keys is checked. When the “volume +” key is pressed and held, a series of codes are transmitted from the same header again. When the pressing of the “volume +” key is not held, the transmission is finished.

Incidentally, a case of remotely controlling an instrument of the other manufacturer, for example a video tape recorder of manufacturer B or a television of manufacturer C, is described as follows. In response to the operation of a predetermined operating key of operating unit 401, control unit 402 uses individual program B or individual program C as shown in FIG. 8 or FIG. 9 to generate transmission format B or transmission format C similarly to the case of transmission format A. Transmitting unit 404 transmits the format as a remote control signal to the instrument to be operated.

Storage unit 403 of the remote control transmitter stores each of different individual programs A, B, C including various data for each transmission format. Control unit 402 generates each transmission format using the individual program for each instrument to be operated, and remotely controls the instrument.

The different transmission formats are individually determined depending on the manufacturer and the kind of the instrument. At the present time, the existence of about 100 kinds of transmission formats is recognized.

In the conventional remote control transmitter, however, when the number of instruments to be remotely controlled is increased, the individual programs for respective transmission formats must be stored in storage unit 403. Therefore, disadvantageously, a microcomputer having large storage capacity is required, the remote control transmitter is expensive, and the designing of the individual program is required as occasion demands.

### SUMMARY OF THE INVENTION

A remote control transmitter comprises an operating unit having a plurality of operating keys, a storage unit for storing data including bit data, an expansion program, and a common program, a control unit for generating a transmission format based on the expansion program, the common program, and the bit data, and a transmitting unit for transmitting the transmission format as a remote control signal.

A transmit/receive system comprises the remote control transmitter and an instrument having a remote control receiver for receiving the transmission format, and remotely controls the instrument.

### BRIEF DESCRIPTION OF THE DRAWINGS

FIG. 1 is a block diagram of a remote control transmitter in accordance with an exemplary embodiment of the present invention.

FIG. 2 is a flowchart of an expansion program of the remote control transmitter in accordance with the exemplary embodiment.

FIG. 3 is a flowchart of a common program of the remote control transmitter in accordance with the exemplary embodiment.

FIG. 4 is a block diagram of a conventional remote control transmitter.

FIG. 5A, FIG. 5B, and FIG. 5C show transmission formats of the conventional remote control transmitter.

FIG. 6 shows bit data.

FIG. 7 is a flowchart of program A.

FIG. 8 is a flowchart of program B.

FIG. 9 is a flowchart of program C.

### DETAILED DESCRIPTION OF THE EXEMPLARY EMBODIMENT

The present invention aims to address the conventional problems, and provides an inexpensive remote control transmitter that easily stores data into a microcomputer even if the number of instruments to be remotely controlled is increased and a transmit/receive system using the transmitter.

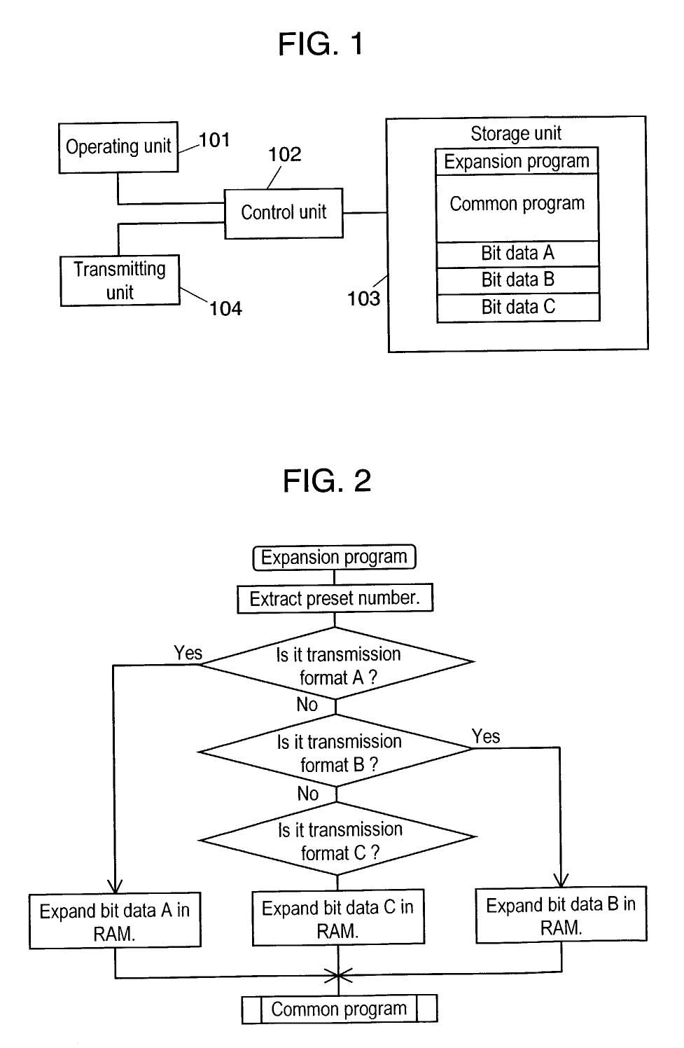

The remote control transmitter and the transmit/receive system in accordance with an exemplary embodiment of the present invention will be described hereinafter with reference to the FIG. 1 to FIG. 3.

(Exemplary Embodiment)

FIG. 1 is a block diagram of a remote control transmitter in accordance with an exemplary embodiment of the present invention.

In FIG. 1, operating unit 101 has a plurality of operating keys, storage unit 103 comprises a microcomputer and various electronic components, and control unit 102 comprises a microcomputer and various electronic components. Storage unit 103 stores various data used for remotely controlling an instrument. Transmitting unit 104 has an infrared light emitting diode and the like. Operating unit 101, storage unit 103, and transmitting unit 104 are connected to control unit 102. Control unit 102 reads data out of storage unit 103 in response to an operation of operating unit 101, and generates a transmission format. Transmitting unit 104 transmits the transmission format as a remote control signal. The remote control transmitter has such a configuration.

Storage unit 103 stores an expansion program, a common program, and a plurality of bit data A, B, C, etc. for remotely controlling an instrument. Control unit 102 reads bit data A, B, C, etc. out of storage unit 103 based on the expansion program and the common program, and generates transmission formats A, B, C, etc. as shown in FIG. 5A to FIG. 5C. The remote control transmitter has such a configuration.

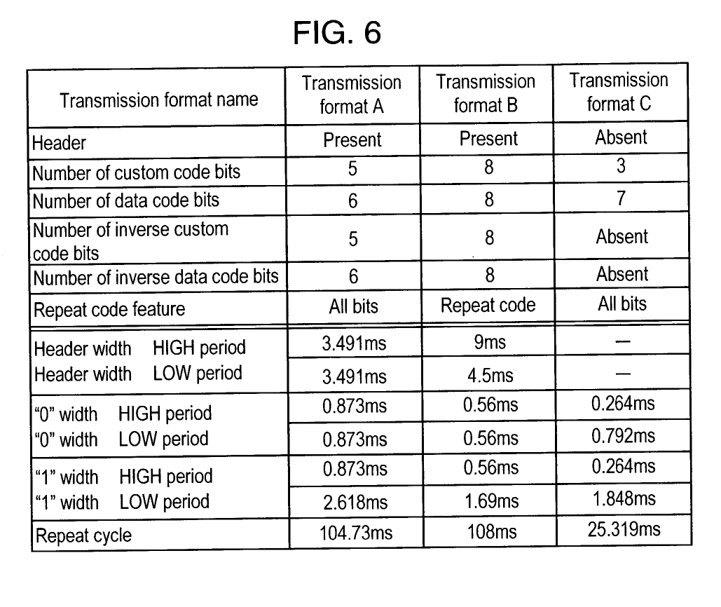

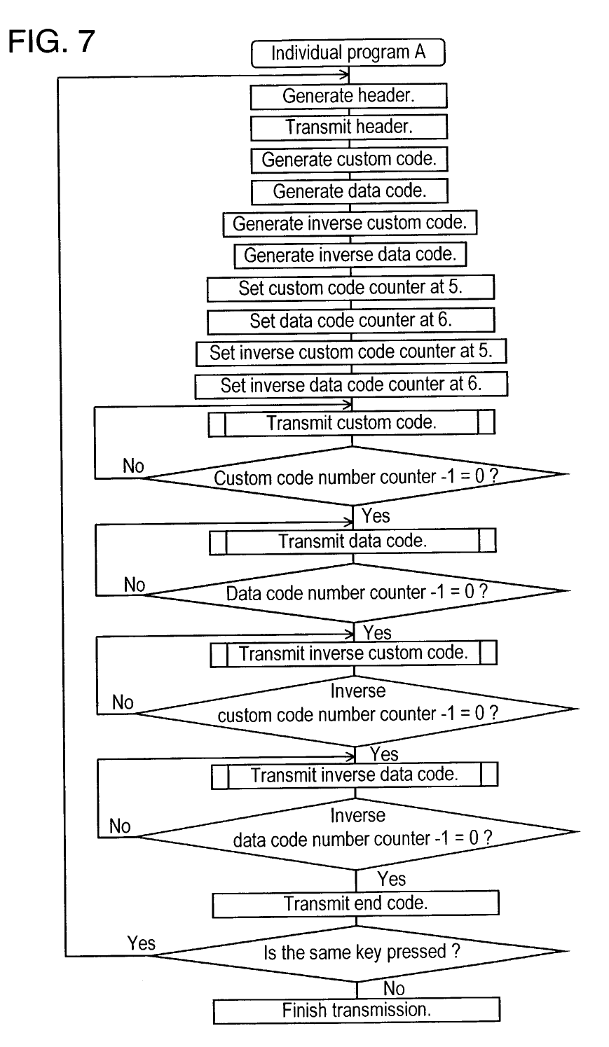

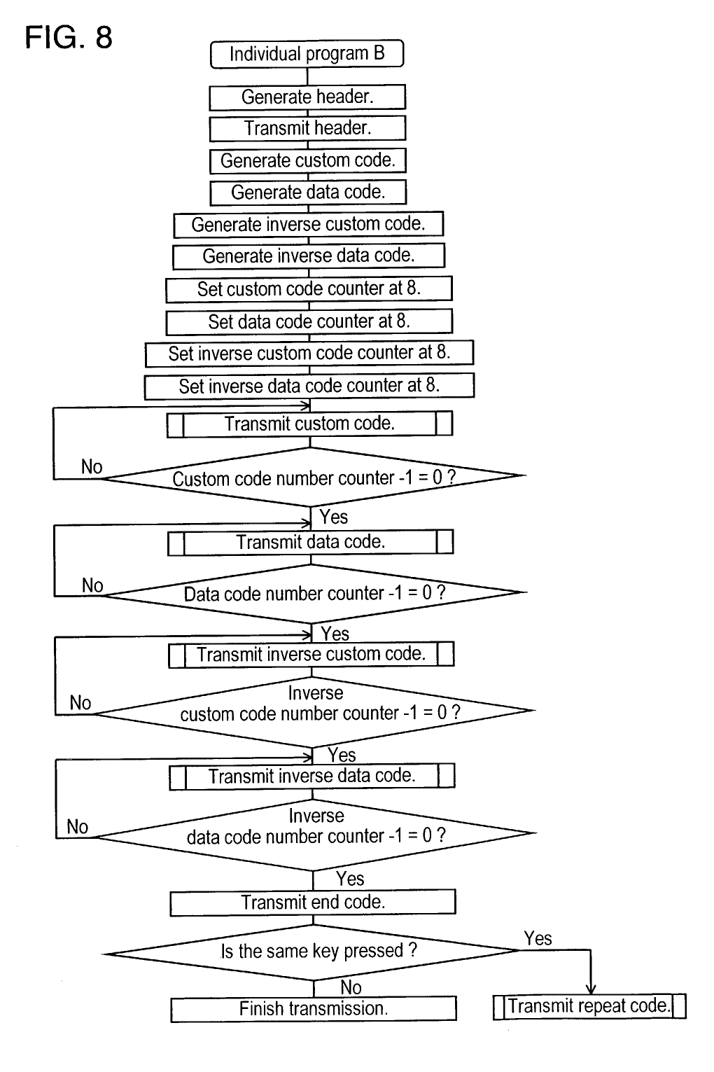

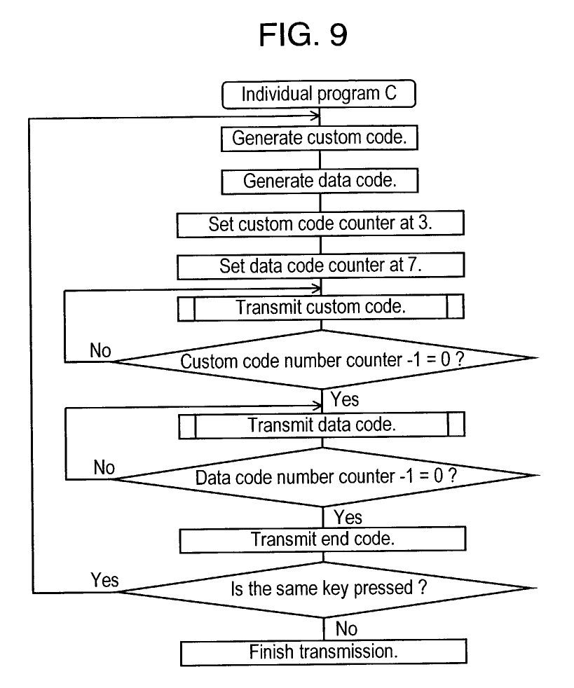

As shown in FIG. 6, each of bit data A, B, C, etc. comprises the number of bits and time width of each of codes such as a header, a custom code, and a data code and various data such as combinations of “0” and “1” for each code.

The common program does not therefore include the various data differently from the conventional individual program, and is configured so that one program can generate a plurality of transmission formats such as transmission formats A, B, C, etc.

When a predetermined operating key of the remote control transmitter having the configuration is operated, control unit 102 reads predetermined bit data out of storage unit 103 and generates a predetermined transmission format. This transmission format is transmitted to a predetermined instrument having a remote control receiver to remotely control the instrument. The transmit/receive system is thus configured.

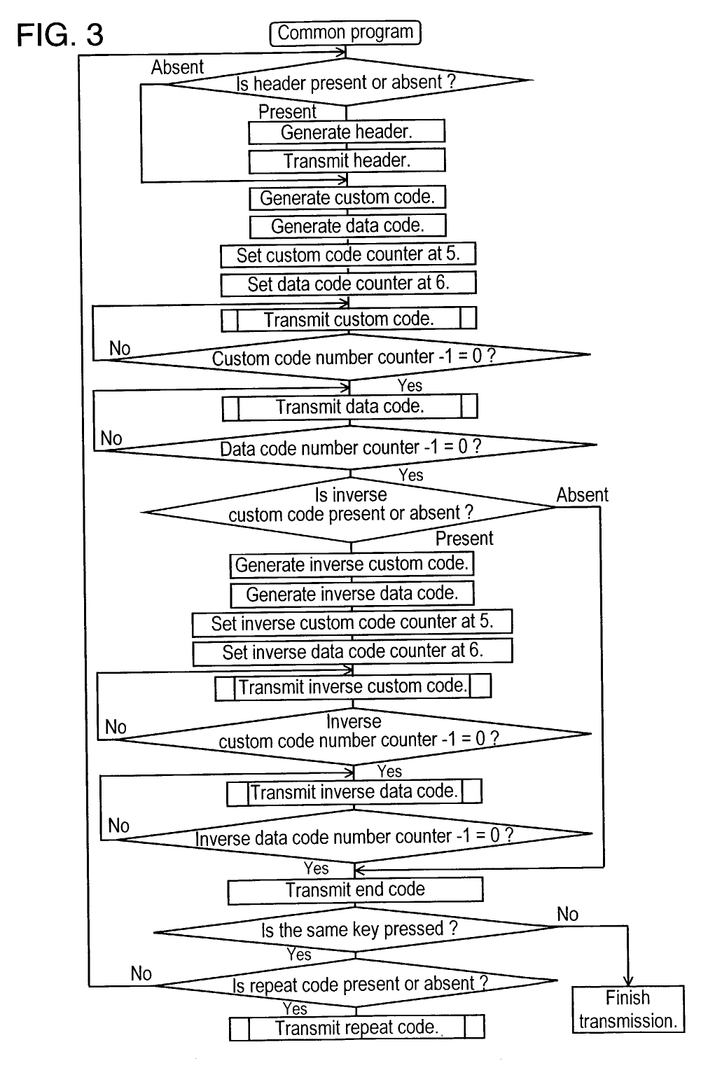

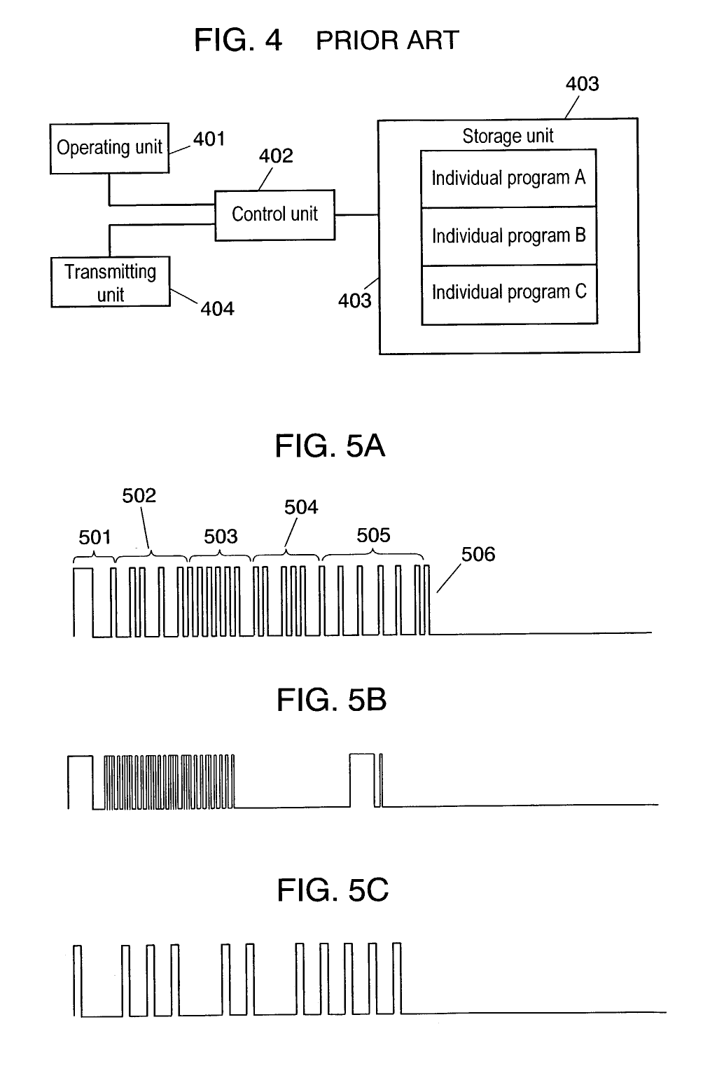

A case of generating and transmitting transmission format A shown in FIG. 5A is described hereinafter with reference to the flowcharts in FIG. 2 and FIG. 3.

Firstly, when “1” key is operated twice while a predetermined operating key of operating unit 101, for example the “power” key, is operated, a television of manufacturer A, for example, is selected. Then, when the “volume +” key is operated, for example, control unit 102 reads bit data A (in the case of transmission format A) out of storage unit 103 based on the expansion program shown in FIG. 2. In a case of transmission format B or transmission format C, control unit 102 reads bit data B or bit data C out of storage unit 103.

Next, the common program shown in FIG. 3 is executed. The existence of the header is firstly recognized. When the header exists as in the case of transmission format A or transmission format B, control unit 102 outputs the HIGH width and the LOW width of the header to transmitting unit 104. Transmitting unit 104 transmits them as a remote control signal such as an infrared ray to an instrument to be remotely operated, for example, a television.

When no header exists as in the case of transmission format C, control unit 102 discriminates and branches the format, does not execute the generation and transmission of the header, and then, subsequently proceeds to a custom code generating program.

Then, in the case of transmission format A, for example, 5 bits of custom code of “10110” and 6 bits of data code of “000001” are generated based on respective HIGH widths and LOW widths of “0” and “1”. The number of bits in the counter of the custom code is set at 5, the counter of the data code is set at 6, and then each code is transmitted from transmitting unit 104 sequentially by 1 bit. At this time, the counter of each code is decremented by 1 in every 1-bit transmission. The 5 bits of custom code is taken as an example. After 5 bits are transmitted, the counter indicates 0 and the next data code is transmitted. The other code is similarly transmitted while the number of bits in it is counted.

Then, the existence of the inverse custom code is recognized. When the inverse custom code and the inverse data code exist as in the case of transmission format A or transmission format B, for example, 5 bits of inverse custom code of “01001” and 6 bits of inverse data code of “111110” are generated. Respective counters of the codes are set at 5 and 6, and then each code is transmitted from transmitting unit 104 sequentially by 1 bit while the number of bits of each code is counted.

When no inverse custom code and no inverse data code exists as in the case of transmission format C, control unit 102 discriminates and branches the format, does not execute the generation and transmission of these inverse codes, and then, subsequently proceeds to a generating program.

An end code is transmitted after the inverse data code.

Then, the input of the operating keys is checked to recognize whether or not the “volume +” key is pressed and held. When the “volume +” key is not pressed and held, the transmission is finished. When the “volume +” key is pressed and held, the existence of a repeat code is recognized. When the repeat code is provided as in transmission format B, the repeat code is transmitted. When the repeat code is not provided, a series of codes are transmitted again from the header.

Transmission format A is thus generated, for example, and is transmitted as a remote control signal carried by such as an infrared ray from transmitting unit 104. A predetermined instrument, for example the receiver of the television of manufacturer A, receives the signal, thereby executing the remote control of the “volume +”, namely increasing the volume of the television.

Incidentally, a case of remotely controlling an instrument of the other manufacturer, for example a video tape recorder of manufacturer B or a television of manufacturer C, is described as follows. In response to the operation of a predetermined operating key of operating unit 101, control unit 102 reads bit data B or bit data C out of storage unit 103 based on the expansion program similarly to the case discussed above. Control unit 102 generates transmission format B or transmission format C based on the common program, and transmitting unit 104 transmits the format as a remote control signal to the instrument to be operated.

In the present embodiment, storage unit 103 stores bit data A, bit data B, bit data C, and the like of a plurality of transmission format A, transmission format B, transmission format C, and the like. Control unit 102 reads a corresponding bit data out of storage unit 103 and generates a predetermined transmission format based on the expansion program and the common program. The remote control transmitter has such a configuration, so that each transmission format can be generated using one common program. As a result, an inexpensive remote control transmitter can be obtained that is required to newly store only bit data even when the number of instruments to be remotely controlled is increased, easily stores data in a microcomputer, and simply requires smaller storage capacity. A transmit/receive system using the remote control transmitter can be also obtained.

Control unit 102 recognizes the existence of each code with the existence recognizing program of each code in the common program, and discriminates and branches a transmission format having no corresponding code, so that the generation of a transmission format can be speedy.

In response to the operation of a predetermined operating key of the remote control transmitter, control unit 102 reads predetermined bit data out of storage unit 103 and generates a predetermined transmission format. This transmission format is transmitted to a predetermined instrument having a remote control receiver, thereby remotely controlling the instrument. The transmit/receive system is thus configured. Thus, an inexpensive transmit/receive system capable of remotely controlling a lot of instruments can be realized.

The present invention can provide an inexpensive remote control transmitter that easily stores data in a microcomputer and simply requires smaller storage capacity, and a transmit/receive system using the remote control transmitter.

What is claimed is:

1. A remote control transmitter comprising:
an operating unit having a plurality of operating keys;
a storage unit for storing data including bit data, an expansion program, and a common program;
a control unit for reading out the data in response to an operation of said operating unit and for generating a transmission format based on the expansion program, the common program, and the bit data; and
a transmitting unit for transmitting the transmission format as a remote control signal.

2. A remote control transmitter according to claim 1,
wherein said control unit recognizes whether information used for generating the transmission format exists in the data and then generates the transmission format.

3. A transmit/receive system comprising:
a remote control transmitter including:
an operating unit having a plurality of operating keys;
a storage unit for storing data including bit data, an expansion program, and a common program;
a control unit for reading out the data in response to an operation of said operating unit and for generating a transmission format based on the expansion program, the common program, and the bit data; and
a transmitting unit for transmitting the transmission format as a remote control signal; and
an instrument having a remote control receiver for receiving the transmission format,
wherein said remote control transmitter remotely controls said instrument.
